(19) United States
(12) Patent Application Publication
(10) Pub. No.: US 2026/0205297 A1
(43) Pub. Date: Jul. 16, 2026

(54) VOTING SYSTEM WITH MULTIPLY ENCRYPTED AND RETRIEVABLE BALLOTS IN OPEN STORAGE

(71) Applicant: Verai Systems Inc., Port Washington, NY (US)

(72) Inventors: Richard L. Przonek, Glen Head, NY (US); Lance D. Reich, Albany, NY (US)

(21) Appl. No.: 19/329,680

(22) Filed: Sep. 16, 2025

Related U.S. Application Data
(63) Continuation-in-part of application No. 19/290,085, filed on Aug. 4, 2025.
Application No. 19/290,085 is a continuation of application No. 18/130,319, filed on Apr. 3, 2023, now Pat. No. 12,381,733.
(63) Continuation-in-part of application No. 18/624,805, filed on Apr. 2, 2024, now Pat. No. 12,494,905.
(60) Provisional application No. 63/456,709, filed on Apr. 3, 2023.

(51) Int. Cl. H04L 9/32; H04L 9/08

(52) U.S. Cl. CPC H04L 9/3231; H04L 9/0819; H04L 9/3213

(57) ABSTRACT

A system and method that allows the open storage of multiply encrypted voting data such that the public can view the storage of electronic voting data from an election, and individual voters can retrieve a copy of their vote from the open storage. The use of multiple encryption guarantees that the voter identity and specific voting data can remain fully protected while other information regarding the vote, such as time and location of casting, can be openly shown. The voter has his or her own personal key that allows only them to retrieve and fully decrypt their original voting data.

### CLAIM TO PRIORITY

This patent application is a Continuation In Part of, and claims priority to, copending U.S. patent application Ser. No. 19/290,085 filed Aug. 4, 2025, and entitled, “Secure Biometric Data Storage and Retrieval System,” which is a Continuation application of U.S. patent application Ser. No. 12/381,733 filed Apr. 3, 2023, and entitled, “Secure Biometric Data Storage and Retrieval System,” the contents of which are hereby incorporated by reference. This patent application is also a Continuation In Part of, and claims priority to, copending U.S. patent application Ser. No. 18/624,805 filed Apr. 2, 2024, and entitled, “Multiple Encryption Data Storage and Retrieval System,” which claims priority to provisional application entitled “Multiple Encryption Data Storage and Retrieval System,” assigned Ser. No. 63/456,709, filed Apr. 3, 2023, the contents of each are hereby incorporated by reference.

### BACKGROUND OF THE INVENTION

### 1. Field of the Invention

The present invention generally relates to computer systems that manage electronic voting. More particularly, the present invention is for a system and method that allows a voter to cast a vote that is multiply encrypted such that the vote is storable and retrievable in encrypted form in an open form and can only be reconstituted into vote data with at least one key from the voter.

2. Description of the Related Art Voting is a method by which a group of people, often called an electorate in political elections, convenes together for the purpose of making a collective decision or expressing an opinion usually following discussions, debates, or election campaigns for public office. True democratic elections will have the holders of high office directly appointed by voting. There are different systems for collecting votes, but while many of the systems used in decision-making can also be used as electoral systems, any which cater to proportional representation can only be used in elections.

The act of voting can occur in many different ways: formally via ballot to elect others for example within a workplace, to elect members of political associations, or to choose roles for others; or informally with a spoken agreement or a gesture like a raised hand, or electronically. Electronic voting uses electronic means to either aid or fully control casting and counting of vote ballots. Depending on the particular implementation, electronic voting may use standalone electronic voting machines or computers connected to the Internet (referred to as online voting). Extant systems can perform some functions across the Internet, from basic transmission of tabulated results to full-function online voting through common connectable household devices. The automated part of the voting can be limited to marking a paper ballot for someone, or can be a comprehensive system of vote input, vote recording, data encryption, data transmission to servers, and consolidation and tabulation of election results.

In most countries, an electronic voting system must comply with a set of standards established by regulatory bodies. An electronic voting system must also be capable to deal successfully with strong requirements associated with such things as security, accuracy, integrity, latency, privacy, auditability, accessibility, cost-effectiveness, scalability and ecological sustainability. Electronic voting technology can include punched cards, optical scan voting systems and specialized voting kiosks, including self-contained direct-recording electronic voting systems. Electronic voting technology can also involve the direct electronic transmission of ballot data from a voting kiosk, or a centralized hub.

In general, there two existing types of electronic voting: voting which is physically supervised by representatives of governmental or independent electoral authorities (e.g., electronic voting machines located at polling stations); and remote e-voting, typically via the Internet, where the voter submits his or her vote electronically to the election authorities, from any location.

Electronic voting technology intends to speed the counting of ballots, reduce the cost of paying staff to count votes manually, and can provide improved accessibility for disabled voters. Election results can be reported and published faster. Furthermore, with remote voting, voters can save time and cost by being able to vote independently from their location, which can increase overall voter turnout.

The history of public distrust of the manner in which elections are held and votes are calculated goes back to the foundations of modern Western society. The ancient Greeks even complained about votes being counted for people not allowed to vote. The issue can be so serious that wars have broken out because people did not trust the results of an election. There are many known methods for rigging an election, such as ballot-box stuffing, ballot destruction, and false counting of votes.

As electronic voting systems have become more complex and include complicated software, different methods of election fraud are possible. Consequently, the natural distrust of election integrity has become acute with electronic voting. Many challenge the use of electronic voting from a theoretical point of view, arguing that humans are not equipped for verifying operations occurring within an electronic machine and that because people cannot verify these operations, the operations cannot be trusted. Some computing experts go so far as arguing that people cannot trust any software programming that is not open and independently verifiable.

Critics of electronic voting argue that all voting be open to public scrutiny to ensure the accuracy of the voting system. Verifiable ballots are necessary because computers can and do malfunction, and because voting machines can be compromised. Key issues with electronic voting are therefore the openness of a system to public examination from outside experts, the creation of an authenticatable paper record of votes cast and a chain of custody for records. There is also the risk that commercial voting machine results could be changed by the company providing the machine, with no guarantee that results are collected and reported accurately. There has been contention, especially in the United States, that electronic voting, could facilitate widespread electoral fraud and may not be fully auditable.

The problem of creating an open electronic voting system that is subject to public review and audit is that the use of the secret ballot (or the “Australian ballot”) in which a voter's identity in an election or a referendum is anonymous. The use of the secret ballot is meant to prevent attempts to influence the voter by intimidation, blackmailing, and potential vote buying. Overall, especially in the United States, the public demands political privacy such that no one can determine how they voted.

But the use of the secret ballot provides problems for auditing and election for voter fraud because votes themselves cannot be linked to a person. Thus, ballot-box stuffing or ballot removal can occur without the ability to detect it.

Accordingly, there is a need to provide a system and method for electronic voting that is open sufficiently to gain the trust of the public yet preserve the secrecy of the vote. Furthermore, it would be advantageous to allow the purposeful linking of a vote to a voter to prevent election fraud by vote rigging. An open public display of significant systemic voting data would also be advantageous to support election integrity.

### SUMMARY OF THE INVENTION

In overview, the present invention is a system and method of electronic voting that allows the open storage of multiply encrypted voting data such that the public can view the storage of electronic voting data from an election, and individual voters can retrieve a copy of their vote from the open storage. The use of multiple encryption guarantees that the voter identity and specific voting data can remain fully protected while other information regarding the vote, such as time and location of casting, can be openly shown. The voter has his or her own personal key that allows only the voter to retrieve and fully decrypt their original voting data, which can be used for auditing purposes.

In one embodiment, the system includes a voting data intake device that intakes voting data from a user, and the voting data intake device is selectively communicably connected to a network and sends and receives data thereacross. The system also includes a voting data management system connected to a network and is in selective communication with the voting data intake device.

The voting data management system is in further communication with at least one open data storage for the selective storage and retrieval of encrypted voting data. The voting data management system is configured to transmit a first encryption key to the voting data intake device for original voting data intake, i.e., to let a voter cast a ballot. The voting data intake device receives the first encryption key from the voting data management system and receives a user key from a user. The user key can be sent to a preferred destination of the voter, such as an email address, text number or directly to a mobile or computer device via a wired or wireless electronic connection.

The voting data intake device will then create a second encryption key from the first encryption key and user key. The voting data intake device will then intake original voting data from the user. The original voting data is then encrypted with the second encryption key to create a first encrypted voting data, and the voting data intake device then transmits the first encrypted voting data to the voting data management system. The voting data intake device stores the second encryption key at a device designated by the user and deletes the second encryption key from the voting data intake device. This prevents any other party than the user casting the vote from fully decrypting the original voting data.

The voting data management system further generates a third encryption key to further encrypt the first encrypted voting data with the third encryption key to create a second encrypted voting data. The voting data management system then stores the second encrypted voting data at an open data storage, such as a Hyperledger, where the public can see the doubly encrypted votes being stored. In such manner, time and location of each vote can be shown such that any significant discrepancy in the vote would be seen, such as too many votes being cast for a location and time, or the disappearance of votes. The open storage can also be checked against the official electronic vote count and records to verify the official voting record.

The present system can use paper ballots that are electronically scanned into an existing voting system such that three records exist: the paper ballots, the electronic official vote, and the open doubly encrypted vote that is viewable and retrievable by the voter who cast the vote. The system can also be used in conjunction with a mail-in voting system to provide an electronic record when the votes are mailed in by a voter. Or simply, the present system can interface with an existing electronic voting system to create the double-encrypted ballots for open storage display.

In an embodiment, the voting data management system further creates a verification token and embeds the verification token with the first encrypted user voting data prior to encrypting the encrypted user voting data with the third encryption key, such that second encrypted user voting data contains the verification token embedded therein. The system then stores the second encrypted user voting data. In this embodiment, when the system receives a user request for the original user voting data, the system retrieves the second encrypted user voting data from the open data storage, the action of which can be embodied as completely viewable to third parties as the ballot is copied from the open storage. The system decrypts the second encrypted user voting data with the third key such that the data becomes first encrypted user voting data and the verification token. The system then verifies the integrity of the verification token which indicates the first encrypted user voting data was successfully stored and retrieved. A plurality of verification tokens can also be utilized within the stored data. The system or device of the user can then decrypt the first encrypted user voting data with the second encryption key received from the user to become original user voting data.

In an embodiment, the voting data management system can transmit the original user voting data to a third-party voting comparison device across the network for auditing purposes. The comparison of stored vote data against other voting records can be transmitted across the network for display.

The present system and method are therefore advantageous as they provide an open public display of significant systemic electronic voting data to support election integrity. The display of the doubly encrypted votes allows the purposeful linking of a vote to a voter to prevent election fraud by vote rigging. The system and method are open sufficiently to gain the trust of the public and allow voters to view the exact vote they cast while still preserve the secrecy of the vote. Furthermore, the present system and method are industrial applications in that they provide an electronic voting system and methodology that can be completely constructed anew, or modify an existing electronic voting machine. This invention can also be used to bolster the integrity of a mail-in voting system. These and other advantages and features of the present invention will become apparent to one of skill in the art after review of the drawings, detailed description of the invention, and the claims herein.

### BRIEF DESCRIPTION OF THE DRAWINGS

FIG. 1 is a representative diagram illustrating one embodiment of the voting data management system using a smartphone mobile device for original voting data occurring from the smartphones interface with a secure electronic voting system.

FIG. 2 is a representative diagram illustrating one embodiment of the voting data management system with a voting data intake device that also scans paper ballots for vote entry.

FIG. 3 is a representative diagram of a smartphone taking a picture of a mail-in ballot for eventual storage on the open storage by the voting data management system.

FIG. 4A is a representative diagram of a touch-screen voting system intaking a vote from a voter.

FIG. 4B is a representative diagram of the touch-screen voting system of FIG. 4A requesting a PIN from a voter (Key 1).

FIG. 4C is a representative diagram of the touch-screen voting system of FIGS. 4A-4B requesting a location for the user voting key to be sent such that the voter can later retrieve an original copy of their vote upon request.

FIG. 5 is a representative view of an embodiment of the open storage vote display available for public inspection and copying across the Internet.

FIG. 6 is a representative view of one embodiment of a voter retrieving an image of their ballot from the open storage with use of the user PIN.

FIG. 7 is a data-flow diagram illustrating one embodiment of the data-flow and processes between the voting data intake device at the user, virtual servers of the voting data management system and an open data storage embodied as a Hyperledger fabric.

FIG. 8 is a data-flow diagram illustrating one embodiment of the data-flow and processes between a user's (voter) mobile device, a secure electronic voting system, the virtual servers of the voting data management system, and the open data storage embodied as a Hyperledger fabric.

FIG. 9 is a flowchart of one embodiment of a process for a user to intake voting data into a voting data intake device.

FIG. 10 is a flowchart of one embodiment of a process for initial setup and intake of encrypted voting data from a user. at the voting data management system, including the use of an embedded verification token in the doubly encrypted voting data.

FIG. 11 is a flowchart of one embodiment of a process for a user to request decryption of stored encrypted voting data at a user device.

FIG. 12 is a flowchart of one embodiment of a process for full decryption of stored user voting data with use of a verification token for data integrity.

### DETAILED DESCRIPTION OF THE INVENTION

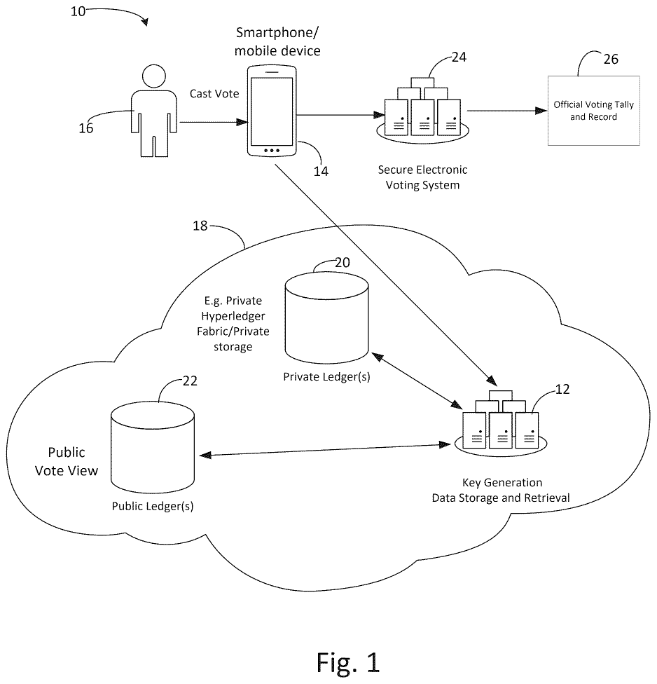

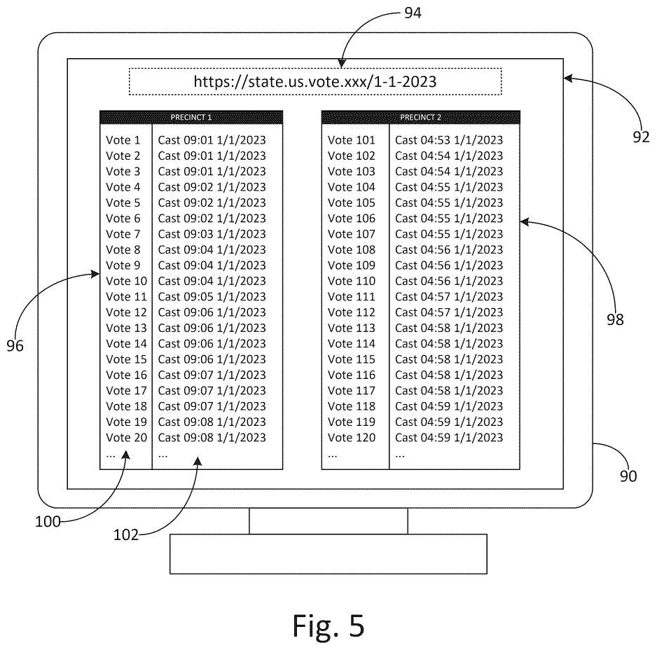

With reference to the figures in which like numeral represent like elements throughout, FIG. 1 is a representative diagram illustrating one embodiment of one architecture of a system 10 for voting data management. Here, a voting data management system 12 (interchangeably referred to herein as the Key Generation Data Storage and Retrieval 12) is embodied as virtual servers connected to a network 18, shown here as the Internet, and voting data management system 12 is in selective communication with the voting data intake device 14, which is embodied here as a smartphone/mobile device for an end user 16 who will vote in an election and then store encrypted voting data on the voting data management system 12 such that they are able to retrieve their vote from an open storage 22. As embodied here, the voting data management system 12 is in further communication with at least one open data storage 22 for the display (FIG. 5) and selective storage and retrieval of encrypted voting data. The data storages shown in this embodiment are a private Hyperledger fabric database 20, as well as a public ledger 22, such as Ethereum or other public blockchain architecture, which can be a Hyperledger as well.

In the embodiment of FIG. 1, the voting data intake device, embodied here a smartphone/mobile device 14 is configured to selectively intake original voting data from an end user 16, such as an electronic vote to a secure electronic voting system 24, and will selectively communicate across the network 18 to encrypt and store that original voting data in the voting data management system 12 as is further described herein. The voting sent to the secure electronic voting system 24 will then be part of the official voting tally and record 26 as would exist in current electronic voting systems.

It should be noted that while the present voting data management system described herein is shown as used in public elections, such system can be used for any voting action, to include shareholder votes of a corporation, proxy listings, as well as bids as part of an auction. In such an embodiment, the present system can likewise be used to place sealed bids on a Hyperledger in a blind auction such that the open storage 22 can be revealed after the bids are closed and a winner of the auction revealed. Accordingly, the present system and method can be used in a synchronous manner, such as mirroring voting occurring in a set timeframe, or they can be used in an asynchronous manner, such as recording mail-in ballots as the votes arrive, as is further described herein.

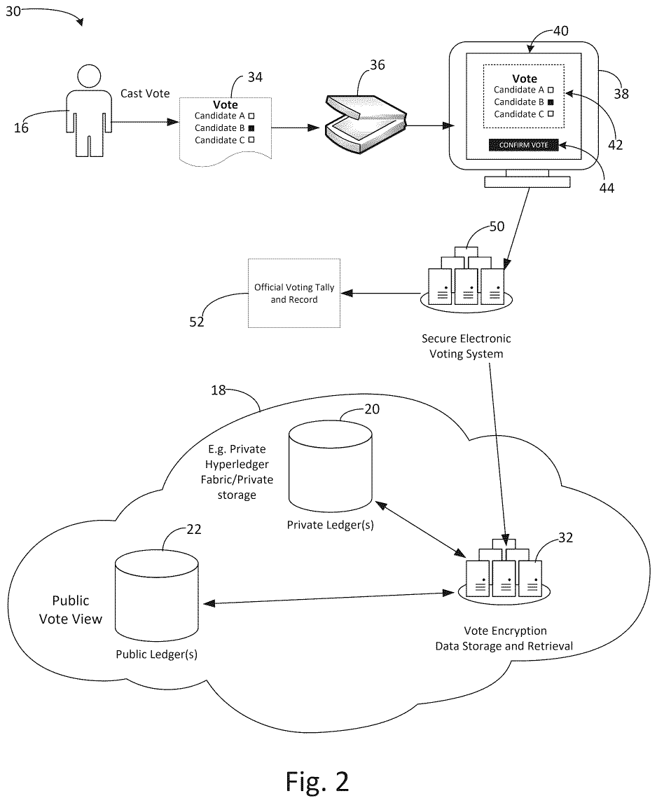

FIG. 2 is a representative diagram illustrating another embodiment of the system 30 for voting data management that allows a user 16 (voter) to cast a point-of-voting ballot 34, and then have that ballot scanned in a scanner 36, which then interfaces with an electronic vote intake device 38. In this embodiment, the voting data intake device 38 optionally includes a touch-screen display 40, and that shows the user his or her vote 42 and has the user confirm the vote at button 44. Once the vote is confirmed, the voting data intake device 38 will send the voting data to the extant secure electronic voting system 50 which will record the vote in the official voting tally and record 52. Thus, this embodiment of the system 30 can be placed upon or interact with an existing secure electronic system 50 without the need to alter the current electronic vote capture and tally in use for a given location or electoral system.

Once the official vote is cast at the secure electronic voting system 50, then voting data is sent to the voting data management system 32, which here is embodied with virtual servers connected to a network 18, shown here as the Internet, but can be any private or public wired or wireless data communication network. The voting data management system 32 is in selective communication with several store devices across the network 18, such as open storage 22 and private ledger/storage 20.

In this embodiment, there is a dedicated electronic voting data intake device 38 that will initially intake voting data from an end user 16 from the paper ballot 34. In this configuration, the user 16 can designate a smartphone/mobile device via text or email (FIG. 4C), that will receive and hold the user key necessary to authorize the decryption of the stored voting data as is further described herein.

As embodied in FIG. 2, the voting data management system 32 is in further communication with at least one data storage for the selective storage and retrieval of encrypted voting data. The data storages shown in this embodiment are a private Hyperledger fabric database 20, as well as a public ledger 22, such as Ethereum or other public blockchain architecture. In this embodiment, the vote data management system 32 can retrieve the vote of the user 16 and can compare the voting records stored and managed by the voting data management system 32 with those of the secure electronic voting system 50. The results of the comparison can be sent to the other devices and persons across the network 18 for purposes of auditing the election. Any discrepancies between the data sets would easily be noticed and indicative of a problem with the vote.

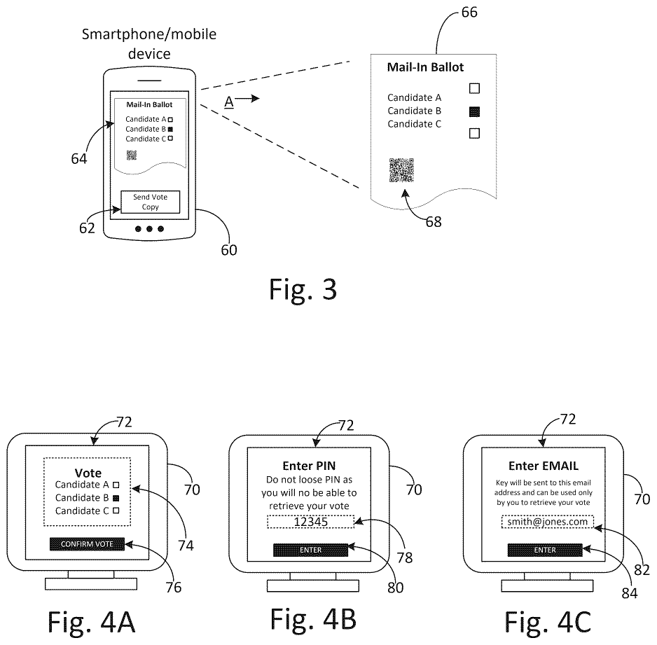

FIG. 3 is a representative diagram of a smartphone 60 taking a picture of a mail-in ballot 66 for eventual storage on the open storage 22 by the voting data management system 12. Here, a voter has voted for Candidate B on a written mail-in ballot 66. The mail-in ballot 66 is embodied herein as optionally including a QR code 68 that identifies the ballot 66. The identification may or may not include the identity of the voter but can be used to identify the ballot 66 itself, and the precinct and election that the vote is being cast in. An application is executed on the smartphone 60 that allows a camera (not shown) to take a picture in the direction of Arrow A of the ballot 66, which will include the QR code 68, or other identifying information on the ballot 66 if present.

A picture 64 of mail-in ballot 66 will appear on the display of the smartphone. Any relevant information regarding the ballot 66, such as that provided by the QR code 68 and/or other identifying information can also be captured by the resident application. Once the voter reviews the image 64 of the ballot 66, the voter can press a send-vote button 62 on the display to send a copy of the image 64, along with any captured data, to the voting data management system 12. The initial key creation (K1,K2) described further herein will occur at the smartphone 60 with the user key resident only thereat for vote retrieval. The mail-in vote can then be displayed as shown in FIG. 5 as the mail-in ballots 66 arrive at the counting location and retrieved by a user as shown FIG. 5.

Additional data can also be included in, and/or attached to, the picture 64 with the ballot 66, such as the driver's license being included with the ballot 66. Alternately, or additionally, the user could put whatever unique item or graphic in the picture sure that they will believe that the picture 64 is intact as originally taken upon retrieval.

If the system is so embodied, the data relative to the capture and posting of the mail-in ballot 66 can be also sent by the voting data management system 12 such that the secure electronic voting system 24 will be aware that the mail-in ballot was sent, potentially including from where and when. Thus, any discrepancies between the open storage 22 and the official voting tally and record 26 would be readily apparent.

FIG. 4A is a representative diagram of a touch-screen voting system 70 intaking a vote from a voter. The display 72 shows the vote 74 and the voter here has selected Candidate B. In this nonlimiting example embodiment, the user 16 (voter) can then confirm their vote by pressing button 76 on the display 72. After pressing the button 76 to cast the vote, the voting system 70 then asks the user/voter for a unique personal identification number (PIN), which is shown here as an alpha-numeric number, but could be any data. For example, the barcode of a driver's license might be scanned at this point to create the PIN in one embodiment. Other embodiments, now known or later developed, may use any suitable computer-based system to enable voter entry of their vote.

FIG. 4B is a representative diagram of the touch-screen voting system 70 of FIG. 4A requesting a PIN (the user key) from a voter (Key 1). The user is prompted on the display 72 to enter a PIN 78 and once the user enters the PIN, they press a button 80 to then generation the unique user key as it further described herein.

FIG. 4C is a representative diagram of the touch-screen voting system 72 of FIGS. 4A-4B, which in this embodiment, requests a location for the user voting key to be sent such that the voter can later retrieve an original copy of their vote upon request. Here, the system 70 requests an email address 82 and once the user 16 types in the address, the user can enter the email address 82 by pressing button 84. After entry, the touch-screen system 70 will generate the unique user key (K3 herein) and send the unique user key to the location specified by the user. The user key could be an e-mail address, phone number, mailing address, or other physical or virtual location chosen by the user/voter.

FIG. 5 is a representative view of an embodiment of the open vote display 92 from open storage 22 available for public inspection and copying across the Internet. The open vote display 92 is shown here a displayed on a monitor 90 at a specific Internet address 94. In such manner, the data of the open vote display 92 can be completely copied and read by anyone but is only writeable and other editable by the voting data management system 12.

In this embodiment, the open vote display 92 is shown as displaying a vote number column 100 and time of vote column 102 for each precinct of the election, e.g. “Precinct 1” 96 and “Precinct 2” 98. In this embodiment, the open vote display 92 is for tracking the votes being cast in real time at the precincts with the time stamps (time of vote column 102). Thus, the public can view all ballots cast for a given precinct, their location, and when they were cast, especially in the appropriate time window, e.g. 9 am-5 pm. Any discrepancies in overall numbers of votes cast for a given location and time would be readily apparent to the public and legitimately call into question the vote integrity.

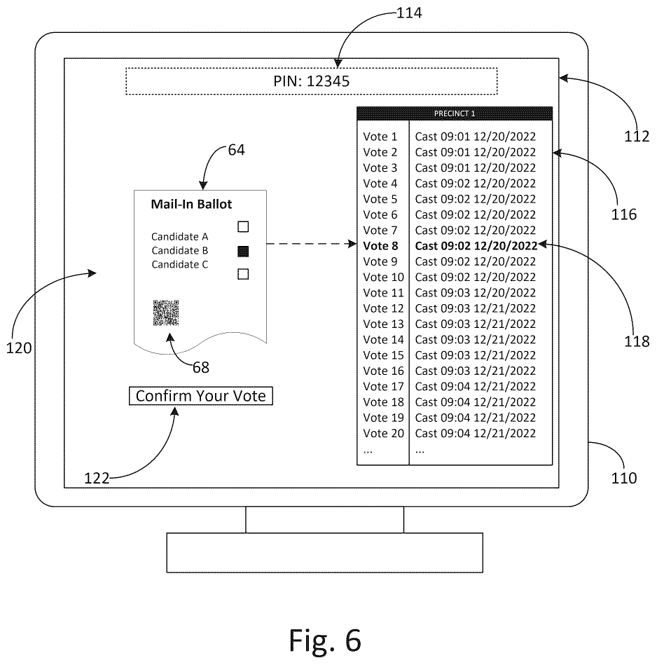

Thus, the voter identity and the vote itself are held securely in double-encryption at the open storage while other salient details of the vote are readily available to the public for immediate inspection. And as repeatedly noted herein, the open vote display 92 can be for a synchronous vote on a secure electronic voting system 50 (FIG. 2) with a specific window in which physical votes are cast. Additionally, or alternatively, the voting data management system 12 can track mail-in ballots 66 (FIG. 3) or other asynchronous voting where the votes intermittently arrive over a longer period of time. When a user/voter wants to see their original voting data, they can use an application on a device, an embodiment of which is shown in FIG. 6.

FIG. 6 is a representative view of one embodiment of a voter retrieving an image of their mail-in ballot 66 (FIG. 3) from the open storage 22 with use of the user PIN 114. The user 16 will open an application at a device, shown here as computer 110, that has the user key (K1) which was created when the user originally recorded their vote, such as taking a picture 64 in FIG. 3. In this embodiment, the user 16 is still prompted to enter their PIN 114 to verify their identity, even though the PIN is only part of the unique user key (Key 3) as described herein.

In this embodiment, in response to an original voting data retrieval request from the user 16, the precinct record 116 (Precinct 1) for all open votes is displayed to the user 16. Additionally, the specific vote item 118 that is the user's vote is optionally shown on the display 112, shown here in FIG. 6 as bolded. This confirms to the user 16 that their specific vote is recorded and shown in the open vote display. The original picture 64 of the mail-in ballot 66 (FIG. 3), including the QR code 68 if so embodied, is then displayed at vote display 120. In this embodiment, the user 16 can confirm that this is their vote by pressing or otherwise actuating button 122.

It should be noted that the voting data management system 12 can be embodied such that verified user 16 vote retrieval data can be utilized, with the permission of the user/voter, for other purposes such as auditing, exit polls, voter records and other applications. The open vote data thus provides a publicly verifiable record of a vote that can be used to check against an official vote tally and record 52 to ensure the integrity of the election.

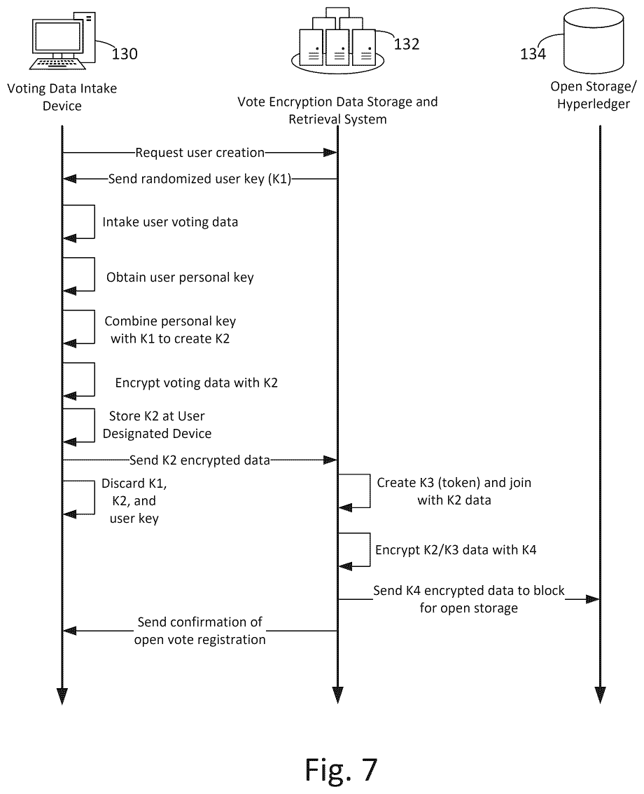

FIG. 7 is a data-flow diagram illustrating the data-flow and processes between the voting data intake device 130, virtual servers of the voting data management system 132, and an open data storage 134, embodied as an open Hyperledger fabric. In this embodiment, upon a request from the voting data intake device 130 to intake a new user's voting data, the user voting data intake device 130 sends a request for vote data intake for user creation to the virtual servers 132, which then transmits a first encryption key (K1) to the voting data intake device 130 for original user voting data intake. The Key K1, or any key described herein can be any standard session random or pseudorandom number of any size. In one embodiment, the key K1 is a 256-bit hexadecimal prime number generated at random.

The voting data intake device 130 then receives the first encryption key (K1) from the virtual servers 132 and intakes user PIN, and then creates a user key from a user. That user key can be any data provided by the user, such as a pin, answer to a question, a word, a key sent from a user device, such as mobile device, or biometric data. The intake of the biometric data can be a single set of a single type of data, such as one or more fingerprints, or can be a set of biometric data, such as fingerprints, a face-scan, retinal image, and DNA. The biometric data can be stored in an open-source or other formats, such as in NIST Biometric Image Software (NBIS), such that the biometric data is usable on common biometric data platforms. This allows selective use of any set of biometric data of the user for identity verification.

The voting data intake device 130 then creates a second encryption key (K2) from the first encryption key and user key, either through hashing or other mathematical operation between the keys. In doing so, this allows the creation of the second key (K2) to be unknown to the virtual servers 132, especially as the local copies of the user key, first key (K1) and second key (K2) are deleted from the voting data intake device 130 as is further described herein. Once the second key (K2) is created, the voting data intake device 130 intakes original user voting data from the user or can be done simultaneously or prior to the creation of second key (K2), and the encrypts the original user voting data with the second encryption key (K2) to create a first encrypted user voting data. If embodied solely with the user 16 mobile device, such as smartphone/mobile device 14 in FIG. 1, as the voting data intake device 130, the intake process can occur solely at the mobile device 14 as described herein.

The encryption can be multiplication, prime-key pair multiplication, elliptical curve cryptography, or any other satisfactory one-way mathematical encryption. The encryption with K2 means that the user's voting data will not be accessible to the voting data management system 132 without K2 being provided from the user 16. This allows the system to be secure against insider theft or attack to access unencrypted user voting data that is stored on or through the system.

The voting data intake device 130 then transmits the first encrypted user voting data to the virtual servers 132 of the voting data management system (32 in FIG. 2) across the network (18 in FIG. 2). In one embodiment, the voting data intake device 130 then stores the second encryption key (K2) at a device (smartphone 14 in FIG. 1) of the user and deletes the second encryption key (and user key and first encryption key (K1) from the voting data intake device 130. If embodied solely with the user mobile device at the voting data intake device, such as smartphone/mobile device 14 in FIG. 1, the mobile device 14 will store the second encryption key (K2) and delete the first encryption key (K1) and user key. The mobile device 14 can also be embodied to be transferred to other devices and locations in a secure manner at the direction of the end user 16.

Upon receipt of the first encrypted user voting data, the virtual servers 132 of voting data management system generate a third encryption key (K3) which serves as a verification token for the encryption and decryption of the first encrypted data. The third key (K3) can be any number of any size, but should be sufficient to supply the belief that error in the verification token will indicate compromise/error of first encrypted data. One or more third keys can also be used and placed with a selected block of first encrypted data before it is encrypted with a fourth key (K4). The virtual servers 132 then create a further key (K4) that it uses to further encrypt the first encrypted user voting data with the third encryption key (K3-verification token) to create a second encrypted user voting data, and then stores the second encrypted user voting data at an open data storage 134, shown here as a Hyperledger fabric. The virtual servers 132 then send a confirmation of storage of the voting data to the voting data intake device 130.

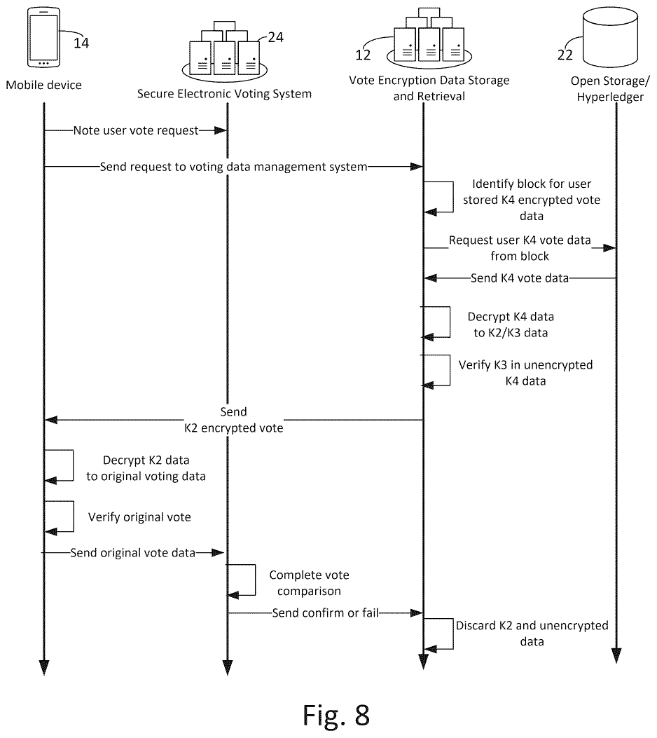

FIG. 8 is a data-flow diagram illustrating one embodiment of the data-flow and processes for retrieval of a user's vote, an embodiment of which is shown in FIG. 6. In this embodiment, which can utilize the system 10 as architected in FIG. 1, the process utilizes a user's mobile device 14, the secure electronic voting system 24 (which is used in this embodiment to verify data integrity with the official vote tally and record 26), the virtual servers of the voting data management system 12, and the open data storage 22 embodied as a Hyperledger fabric. The mobile device 14 of the user sends a user vote verification request for the user voting data to both secure electronic voting system 24 and the virtual servers of the voting data management system 12. The second encryption key (K2) will be resident at the mobile device 14 as it was created at the time the vote was cast.

Once the user request is received, the voting data management system 12 then identifies the specific storage block(s) of for the doubly-encrypted user stored voting data at the open storage/Hyperledger 22, then requests that block from the Hyperledger 22 to retrieve the vote comprising the second encrypted user voting data from the Hyperledger 22 data storage. The Hyperledger 22 then sends a copy of the block(s) of second encrypted user voting data (K4 encrypted) to the voting data management system 12.

The voting data management system 12 then decrypts the second encrypted user voting data with the fourth key (K4) such that the data becomes first unencrypted user voting data and the verification token(s) (K3). The virtual servers 64 can then verify the integrity of the verification token(s) (K3). The voting data management system 12 then sends the K2 encrypted vote data to the mobile device 14. The mobile device 14 can then fully decrypt the original vote data of the user with the resident K2 to display the voting record to the user 16. The mobile device 14 can then send a confirm or fail to the secure electronic voting system 24 to inform the authority of any discrepancy between the retrieved vote and what the user believed should be correct. The secure electronic voting system 24 can also send the confirm or fail to the voting data management system 12 for auditing purposes or to cause further inquiry as to if an erroneous vote is believed to have been recorded.

In this embodiment, the voting data management system 12 also discards and K2 data or other data from the transaction to further guarantee user/voter privacy. The voting data management system 12 can also store a record of the transaction and can interact with the secure electronic voting system 24 to make a record of the particulars of the transaction including the confirmation of the vote verification.

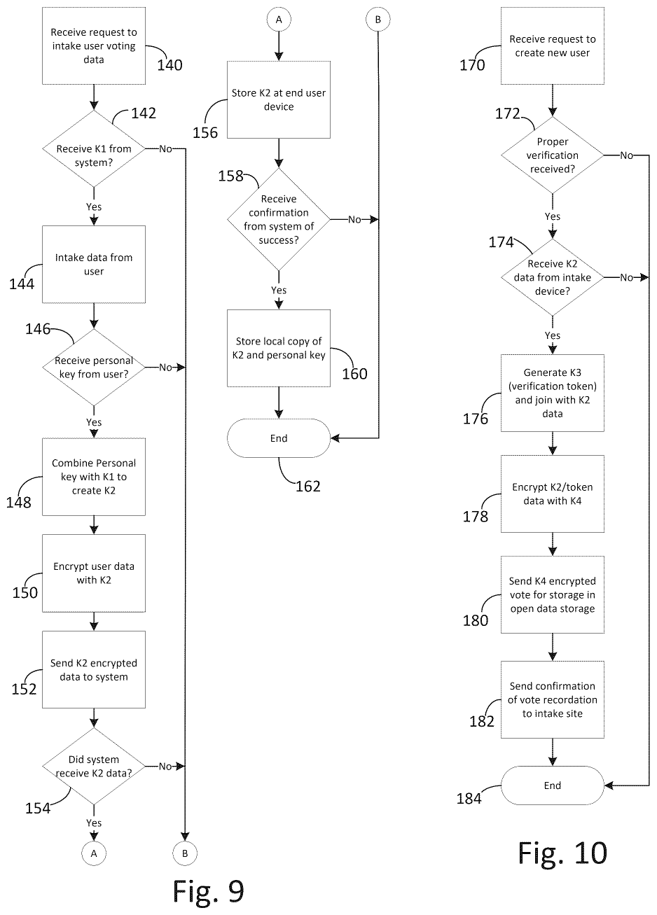

FIG. 9 is a flowchart of one embodiment of a process for a user to intake voting data into a voting data intake device, such as voting data intake device 38 in FIG. 2 and voting data intake device 70 in FIGS. 4A-4C. The process in FIG. 9 is similar to that shown in the dataflow of FIG. 7. The voting data intake device 38 receives a request to create a new user and intake voting information to the secure electronic voting system 50, as shown at step 140, and then a determination is made as to whether the first encryption key (K1) has been received from the voting data management system 32, as shown at decision 142. If the first encryption key (K1) has not been received at decision 72, then the process forwards to end, at termination 162. Otherwise, if the first encryption key (K1) has been received at decision 142, then the device intakes the voting data from the user (end user 16 in FIG. 2), as shown at step 144, and then a determination is made as to whether a personal user key has been received from the user, as shown at decision 146.

If the personal user key has not been received at decision 146, then the process forwards to end, at termination 162. The voting data intake device 38 then combines the personal user key with the first encryption key (K1) to create a second encryption key (K2), as shown at step 148, and the user voting data is encrypted with the second encryption key (K2) as shown at step 150. Then the first encrypted data is sent to the voting data management system 32, as shown at step 152, and then a determination is made as to whether the voting data management system 32 received the first encrypted user voting data set, as shown at decision 154. If the system 32 did not receive the first encrypted voting data set at decision 154, then the process forwards to end at termination 162. Otherwise, if the first encrypted user voting data set has been received at the voting data management system at decision 154, then the second encryption key (K2) is stored at the voting data intake device 38 at step 156.

Then a determination is made as to whether a confirmation has been received from the voting data management system 32 as to whether the first encrypted user voting data was successfully stored by the system, as shown at decision 158. If confirmation is not received at decision 158, then the process forwards to end at termination 162. Otherwise, if the confirmation is received at decision 158, then the user personal key and the second encryption key (K2) are stored at the voting data intake device 38, as shown at step 160, or the PIN and K2 are sent to a location of the user's choosing (FIG. 4C), and then the process ends at termination 162.

FIG. 10 is a flowchart of one embodiment of a process for initial setup and intake of encrypted voting data from a user at the voting data management system 32, FIG. 2, including the use of an embedded verification token in the doubly encrypted voting data. The process in FIG. 10 is similar to that shown in the dataflow of FIG. 7. The process begins with the voting data management system 32 receiving a request to create a new user vote from the voting data intake device 38, as shown at step 170. Then a determination is made as to whether a proper verification of the voting data intake device 38 is received, as shown at decision 172. The proper verification of the voting device intake device 38 can be a key, such as an official key, or other security verification that the device can properly intake user voting data and upload the user voting data to the voting data management system 32 for the session.

If verification does not occur at decision 172, then the process forwards to end at termination 184. Otherwise, if verification does occur at decision 172, then a determination is made as to whether the first encrypted user voting data (K2 encrypted) has been received from the voting data intake device 38, as shown by decision 174. If the first encrypted user voting data has not been received at decision 174, then the process forwards to end at termination 184. Otherwise, if the first encrypted user voting data is received at decision 174, then the voting data management system 32 generates one or more third encryption keys (K3) as a verification token and joins the one or more third encryption keys (K3) to the first encrypted user voting data, as shown at step 176. Then the first encrypted user voting data and the verification token (K3) are encrypted with a fourth encryption key (K4), as shown at step 178, to create a second encrypted user voting data.

Then the second encrypted user voting data (K4 encrypted) is sent to an open data storage, such as Hyperledger fabric 22, for storage in one or more blocks, as shown at step 180. The storage can also include private storage, depending on preference. Then the voting data management system 32 sends confirmation to the voting data intake device 38 of storage of the second encrypted voting data, as shown at step 182, and then the process ends at termination 184.

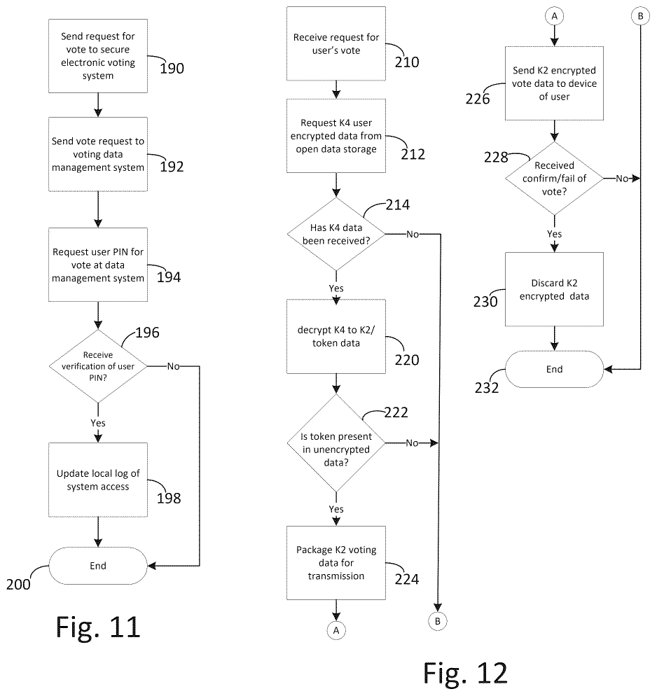

FIG. 11 is a flowchart of one embodiment of a process for a user (e.g., end user 16 in FIG. 2) to request their vote (FIG. 6). The process in FIG. 11 is similar to that shown in the dataflow of FIG. 8. The process starts when the user (end user 16), through their user mobile device (14 in FIG. 2) in this embodiment, sends an authorization for retrieval of their vote, to the secure electronic voting system 24, as shown at step 190, and then sends a transaction authorization to the voting data management system 32, as shown at step 192. Then the user mobile device 14 can request the voting PIN, through an application interface to prove identity, as shown at step 194. Then a determination is made as to whether the PIN verification for the user identity has been approved at the user device, as shown at decision 196.

If the authorization of the PIN verification has not been received at decision 196, then the process forwards to end at termination 200. If the authorization has been received at decision 196, then the local log of voting data management system 32 is updated at step 198, and the process ends at termination 200 to await vote retrieval. Step 198 is merely an embodiment and is not required to perform the process described herein.

FIG. 12 is a flowchart of one embodiment of a process for full decryption of stored original voting data with use of a verification token for data integrity at the voting data management system 32. The process in FIG. 12 is similar to that shown in the dataflow of FIG. 8. The process begins when the voting data management system receives a request from a user 16, either from the user mobile device 14 or the voting data intake device 38, or another device where K2 has been stored, as shown at step 210. Then the voting data management system 32 requests the user's second encrypted user voting data (K4 encrypted) from the open data storage, such as Hyperledger fabric 22, as shown at step 212. In this embodiment, the second encrypted user voting data (K4 encrypted) is requested from the stored encrypted user voting data from the one or more blocks where the data is stored. A determination is then made on whether the second encrypted user voting data has been received, as shown at decision 214.

If the second encrypted user voting data has not been received at decision 214, then the process forwards to end at termination 232. Otherwise, if the data has been received at decision 214, then the voting data management system 32 decrypts the second encrypted user voting data to be the first unencrypted user voting data (K2 encrypted data) and the verification token (K3), as shown at step 220.

A determination is then made on whether the intact verification token (K3) is present in the unencrypted data, as shown in decision 222. If multiple verification tokens are present in multiple block of unencrypted data, then decision 222 can be the iteration through all data integrity checks in the newly decrypted data. If the verification token is not intact at decision 222, then the process forwards to end at termination 232. Otherwise, if the verification token(s) is intact at decision 222, then K2 encrypted voting data is packaged, as shown at step 224 and sent to the user 16 to become unencrypted original user voting data, as shown at step 226.

After step 226, a determination is made as to whether the user identity was confirmed or failed at the mobile device 14, or secure electronic voting system 24, as shown at decision 228. If the confirm/fail has not been received at decision 228, then the process forwards to end at termination 232. Otherwise, if the confirm/fail is received at decision 228, then the voting data management system 32 discards the second encryption key (K2), as shown at step 230, and the process ends at termination 232.

It should be appreciated that one of skill in the art would be able to have different parts of the processes descried herein performed by different devices at different locations, either locally or remotely located. For example, the K2 encrypted data can be sent to a location of the user's choosing, or only be restricted to the voting data intake device, such as mobile device 14. Furthermore, the use of keys can be done singularly or in multiple with keys apportioned to data blocks for either encryption or data integrity verification as is known in the art.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A voting system for open storage and retrieval of multiply encrypted votes, comprising:
a voting data intake device configured to selectively intake voting data from a user, the voting data intake device selectively communicably connected to a network and sending and receiving data thereacross;
a voting data management system connected to the network and in selective communication with the voting data intake device, the voting data management system in further communication with at least one open data storage for the selective storage and retrieval of encrypted voting data;
wherein the voting data management system is selectively configured to transmit a first encryption key to the voting data intake device for original voting data intake;
wherein the voting data intake device receiving the first encryption key from the voting data management system and further configured to:
receive a user key from the user;
create a second encryption key from the first encryption key and the user key;
intake the original voting data from the user;
encrypt the original voting data with the second encryption key to create a first encrypted voting data;
transmit the first encrypted voting data to the voting data management system;
store the second encryption key at a device of the user;
delete the second encryption key from the voting data intake device;
wherein the voting data management system further configured to:
generate a third encryption key;
further encrypt the first encrypted voting data with the third encryption key to create a second encrypted voting data; and
store the second encrypted voting data at the at least one open data storage.

2. The system of claim 1, wherein the voting data management system is further configured to:
create a verification token;
embed the verification token with the first encrypted voting data prior to encrypting the encrypted voting data with the third encryption key to become the second encrypted voting data; and
store the second encrypted voting data with the verification token embedded therein.

3. The system of claim 2, wherein the voting data management system is further configured to:
receive a user request for the original voting data;
retrieve the second encrypted voting data from the open data storage;
decrypt the second encrypted voting data with the third key such that the data becomes the first unencrypted voting data and the verification token;
verify integrity of the verification token;

4. The system of claim 3, wherein the voting data intake device further decrypts the first encrypted voting data with the second encryption key to become original voting data.

5. The system of claim 4, wherein the voting data management system further configured to transmit the original voting data to a third-party device across the network.

6. The system of claim 1, wherein the voting data management system is further configured to store the second encrypted voting data at a data storage across the network.

7. The system of claim 1, wherein the voting data management system is further configured to store the second encrypted voting data in Hyperledger fabric.

8. The system of claim 1, wherein the voting data management system is further configured to store the second encrypted user voting data on an open internet-accessible website.

9. A method of storing and retrieving multiply encrypted voting data, comprising the steps of:
communicating a request to intake original voting data from a voting data intake device to a voting data management system, the voting data intake device selectively communicably connected to a network and sending and receiving data thereacross;
transmitting a first encryption key from the voting data management system to the voting data intake device, the voting data management system connected to the network and in selective communication with the voting data intake device;
the voting data intake device further:
receiving the first encryption key from the voting data management system;
receiving a user key from a user;
creating a second encryption key from the first encryption key and the user key;
intaking at the voting data intake device the original voting data from the user;
encrypting the original voting data with the second encryption key to create a first encrypted user voting data;
transmitting the first encrypted user voting data to the voting data management system;
storing the second encryption key at a designated device of the user; and
deleting the second encryption key from the voting data intake device;
the voting data management system further:
generating a third encryption key;
encrypting the first encrypted user voting data with the third encryption key to create a second encrypted user voting data; and
storing the second encrypted user voting data at, at least, an open data storage.

10. The method of claim 9, wherein, at the voting data management system, further:
creating a verification token;
embedding the verification token with the first encrypted user voting data prior to encrypting the encrypted user voting data with the third encryption key to become the second encrypted user voting data; and
storing the second encrypted user voting data with the verification token embedded therein.

11. The method of claim 10, wherein, at the voting data management system, further:
receiving a user request for the original voting data, the request including the second encryption key;
retrieving the second encrypted user voting data from the open data storage;
decrypting the second encrypted user voting data with the third key such that the data becomes the first unencrypted user voting data and the verification token;
verifying integrity of the verification token; and
decrypting the first encrypted user voting data with the second encryption key to become original user voting data.

12. The method of claim 11, wherein, at the voting data management system, further transmitting the original user voting data to another device across the network.

13. The method of claim 11, wherein, at the voting data management system, further:
retrieving the original voting data;
comparing the retrieved user voting data against the unencrypted original voting data to determine a matching status; and
transmitting the matching status to the another device across the network.

14. The method of claim 9, wherein, at the voting data management system, further storing the second encrypted user voting data at the open data storage across the network.

15. The method of claim 9, wherein, at the voting data management system, further storing the second encrypted user voting data in Hyperledger fabric.

16. The method of claim 15, wherein, at the voting data management system, further storing the second encrypted user voting data in a public blockchain.

17. A system for storage and retrieval of encrypted voting data, comprising:
a voting data intake means for selectively intaking original voting data from a user, the voting data intake means selectively communicably connected to a network and sending and receiving data thereacross;
a voting data management means for managing the storage and retrieval of encrypted voting data, the voting data means connected to the network and in selective communication with the voting data intake means, the voting data management means in further communication with at least one open data storage means for the selective storage and retrieval of the encrypted voting data, wherein the voting data management means further for transmitting a first encryption key to the voting data intake means for original user voting data intake;
wherein the voting data intake means further for:
receiving the first encryption key from the voting data management means receiving a user key from the user;
creating a second encryption key from the first encryption key and the user key;
intaking original user voting data from the user;
encrypting the original user voting data with the second encryption key to create a first encrypted user voting data;
transmitting the first encrypted user voting data to the voting data management means;
storing the second encryption key at a device of the user;
deleting the second encryption key from the voting data intake means;
wherein the voting data management means further for:
generating a third encryption key;
encrypting the first encrypted user voting data with the third encryption key to create a second encrypted user voting data; and
storing the second encrypted user voting data at an open data storage means for storing data that is openly readable.

18. The system of claim 17, wherein the voting data management means further for:
creating a verification token;
embedding the verification token with the first encrypted user voting data prior to encrypting the encrypted user voting data with the third encryption key to become second encrypted user voting data; and
storing the second encrypted user voting data with the verification token embedded therein.

19. The system of claim 17, wherein the voting data management means further for:
receiving a user request for the original user voting data;
retrieving the second encrypted user voting data from the open data storage means;
decrypting the second encrypted user voting data with the third key such that the data becomes first unencrypted user voting data and the verification token;
verifying the integrity of the verification token;
decrypting the first encrypted user voting data with the second encryption key to become the original user voting data.

20. The system of claim 19, wherein the voting data management means further for transmitting the original user voting data to a comparison means for comparing retrieved user voting data with original user voting data.
